(19) United States
(12) Patent Application Publication
(10) Pub. No.: US 2016/0339526 A1
(43) Pub. Date: Nov. 24, 2016

(54) TOOL FOR MACHINING A WORKPIECE

(71) Applicant: Hartmetall-Werkzeugfabrik Paul Horn GmbH, Tuebingen (DE)

(72) Inventors: Matthias Luik, Reutlingen (DE); Marc Steinhilber, Moessingen (DE)

(21) Appl. No.: 15/224,830

(22) Filed: Aug. 1, 2016

Related U.S. Application Data
(63) Continuation of application No. PCT/EP2014/075571, filed on Nov. 25, 2014.

(30) Foreign Application Priority Data
Feb. 18, 2014 (DE) 10 2014 102 019.7

(51) Int. Cl. B23B 27/16

(52) U.S. Cl. CPC B23B 27/164; B23B 2200/0423; B23B 2205/02; B23B 2220/126

(57) ABSTRACT

A tool for machining a workpiece, comprising a cutting insert and a tool holder, which has a main body, an upper clamping finger and a lower clamping finger, wherein the main body extends along a longitudinal direction (x) from a holder-side end to a workpiece-side end. A projecting part of the lower clamping finger projects over the workpiece-side end of the main body. The upper clamping finger and the lower clamping finger together form a receiving fixture for the cutting insert, in which the cutting insert may be fixed such that the upper clamping finger, via an upper clamping surface disposed thereon, exerts a clamping force on the cutting insert. At least a part of the upper clamping surface is disposed between the workpiece-side end and the holder-side end of the main body, and a force vector of the clamping force acts in a region which is located between the workpiece-side end and the holder-side end of the main body. The projecting part of the lower clamping finger has a substantially crescent-shaped or arc-shaped cross section.

### CROSS REFERENCES TO RELATED APPLICATIONS

This application is a continuation of international patent application PCT/EP2014/075571, filed on Nov. 25, 2014 designating the U.S., which international patent application has been published in German language and claims priority from German patent application DE 10 2014 102 019.7, filed on Feb. 18, 2014. The entire contents of these priority applications are incorporated herein by reference.

### BACKGROUND OF THE INVENTION

This disclosure relates to a tool for machining a workpiece, in particular for axial grooving, comprising a cutting insert and a tool holder, which latter has a main body, an upper clamping finger and a lower clamping finger, wherein the main body extends substantially along a longitudinal direction (x) from a holder-side end to a workpiece-side end. At least a part of the lower clamping finger projects over the workpiece-side end of the main body. The upper clamping finger and the lower clamping finger jointly form a receiving fixture for the cutting insert, in which the cutting insert is securable by means of an actuating element such that the upper clamping finger, via an upper clamping surface disposed thereon, exerts a clamping force on the cutting insert.

Tools of the present type are generally used in applications for metal working, in particular in turning operations. Typically the cutting insert is in this case held by the tool holder. For its part, the tool holder is connected by means of an appropriate fixing mechanism or holding apparatus to a machine tool which allows movement relative to a workpiece. The workpiece is in this case generally driven rotationally in relation to the cutting insert, so that the cutting insert, upon contact with the workpiece, can remove material therefrom.

Axial grooving denotes the machining of the workpiece parallel to the rotational axis of the workpiece, wherein a feed of the tool or of the workpiece usually takes place in the axial direction and, for instance, an annular groove is turned or recessed. Axial grooving is also referred to as longitudinal groove turning.

In order to save costs and procurement time, the trend in the field of machining tools is toward tools which can cover a greatest possible range of use. In particular in axial grooving, but also in further turning methods, stability problems or oscillation of the tool frequently occur, whereby plunge depth and cutting speed are limited. For this reason, a stable design of the tool is necessary. The use of cutting inserts of higher strength is only conditionally possible. More effective and economical is often the optimization of the tool holder holding the cutting insert, in particular by the provision of a support for the cutting insert. Particularly in applications which call for a relatively large plunge depth with a relatively low width, the stability of the tool is of great importance. A higher stability of the tool leads to smoother running, which can have a positive effect on tool life and feed rate or cutting speed.

In previous versions of such tools for grooving, the tool holder usually has a main body, on which an upper clamping finger and a lower clamping finger are provided for the reception of the cutting insert. Generally, the cutting insert is secured between the upper clamping finger and the lower clamping finger by application of a clamping force to the cutting insert by means of the upper clamping finger. In order to achieve a secure seating of the cutting insert, it is necessary that the clamping force is sufficiently strong.

A drawback of a high clamping force is, however, that the lower clamping finger, which is also referred to as the support, must be made appropriately stable to be able to absorb the clamping force which acts on it through the cutting insert. However, in various applications a stable support can be achieved only with difficulty, or for various reasons is unachievable.

For instance, in axial grooving the support must be of substantially crescent-shaped or arc-shaped design, wherein the radius of the circular arc also corresponds to the radius of the desired annular groove. If not only a predefined dimensioning of an annular groove is meant to be possible, it is necessary for the support to have a different inside and outside radius. As a result, annular grooves with various radii can then be achieved, which is often desirable with a view to a flexibly usable tool. As a result of the crescent-shaped design of the support, the support can hence not be dimensioned according to choice and thus stably designed. A balance between the stability of the support or lower clamping finger and the dimensioning of the clamping force exerted by the upper clamping finger is therefore obtained. Particularly in the axial grooving of small radii and with relatively large plunge depths, this balance is of high relevance.

### SUMMARY OF THE INVENTION

It is thus an object to optimize a tool for machining a workpiece. In particular, the tool is intended to be optimized such that an axial grooving is possible even in respect of small radii and/or larger plunge depths. It is additionally an object of this disclosure to improve the stability of a tool for machining a workpiece, in order to thus broaden the range of use of the tool and to increase the economic efficiency.

In view of this object, a tool for machining a workpiece is provided, comprising a cutting insert and a tool holder, which has a main body, an upper clamping finger and a lower clamping finger. The main body extends along a longitudinal direction (x) from a holder-side end to a workpiece-side end. A projecting part of the lower clamping finger projects over the workpiece-side end of the main body. The upper clamping finger and the lower clamping finger together form a receiving fixture for the cutting insert, in which the cutting insert may be fixed such that the upper clamping finger, via an upper clamping surface disposed thereon, exerts a clamping force on the cutting insert, wherein at least a part of the upper clamping surface is, considered along the longitudinal direction, disposed between the workpiece-side end and the holder-side end of the main body, and a force vector of the clamping force acts in a region which is, considered along the longitudinal direction, located between the workpiece-side end and the holder-side end of the main body. The projecting part of the lower clamping finger has a substantially crescent-shaped or arc-shaped cross section.

This disclosure is not limited to tools for axial grooving, but can also be of benefit for other turning tools. As already stated, the cutting insert is secured in the tool holder between an upper clamping finger and a lower clamping finger, i.e. clampingly fixed. In order to achieve this securement, an actuating element which allows the two clamping fingers to move closer together is provided. In order to allow a plunging or penetration of the cutting insert into the workpiece, at least the cutting insert must project over the main body of the tool holder. The length of this projecting part of the cutting insert beyond the main body in the longitudinal direction limits the plunge depth.

During the machining of a workpiece, the cutting insert is acted on by a force which is dependent on the material that is machined and the feed rate that is operated. This force must be absorbed by the tool holder or led off and acts in particular on the lower clamping finger. In addition to the force which acts on the cutting insert during the machining of a workpiece, the upper clamping finger also exerts a clamping force which, via an upper clamping surface on the upper clamping finger, acts on the cutting insert. This clamping force results in a corresponding force which is exerted on the lower clamping finger by the cutting insert. Depending on the place at which this resultant force acts on the lower clamping finger, an additional load on the lower clamping finger, and in particular in its projecting part, the support, is thus obtained.

In order nevertheless to enable a small dimensioning of the lower clamping finger or of the support, this disclosure provides that at least a part of the upper clamping surface, considered along the longitudinal direction, is disposed between the workpiece-side end and the holder-side end of the main body. The clamping force acts areally from the upper clamping finger into the cutting insert and is led off areally from the cutting insert into the lower clamping finger. At least a part of the clamping force acting on the cutting insert is not led off into the projecting part of the lower clamping finger, i.e. into the support, but is diverted from the cutting insert directly into the main body of the holder. This is achieved by virtue of the fact that the upper clamping surface is not disposed fully over the projecting part of the lower clamping finger, but at least partially within the main body. The upper clamping surface is hence set back from the lower clamping finger, in particular from the projecting part thereof, in the longitudinal direction. The clamping force exerted on cutting insert is thus transmitted from the cutting insert only in part to the lower clamping finger in its projecting part. Rather, the majority of the clamping force is transferred directly into the main body.

Furthermore, according to this disclosure, a resultant force vector of the clamping force acts in a region which, considered along the longitudinal direction, is located between the workpiece-side end and the holder-side end of the main body. If the clamping force is integrated and a resultant force vector is determined, then the latter acts not in the projecting part of the lower clamping finger, but in that part of the lower clamping finger which is located within the main body and thus anyway has a higher stability. The resultant force vector denotes an imaginary force vector which corresponds to a sum of the areally acting clamping force. The resultant force vector thus acts directly into the main body, whereby a lower load upon the projecting part of the lower clamping finger is achieved. It is possible that the upper clamping force exerts different force profiles in relation to an upper bearing surface on the cutting insert. For instance, more than half of the upper clamping surface can lie above the projecting part of the lower clamping finger, yet the force can act above all in a region which does not lie at the height of the projecting part, but it ends up further to the rear at the height of the main body, so that the resultant force vector nevertheless acts in a region within the main body.

The inventive design of the tool, and in particular of the tool holder, hence offers the advantage that a smaller dimensioning of the projecting part of the lower clamping finger, i.e. the support, is enabled. As a result, in axial grooving, for instance, smaller radii and/or larger plunge depths are enabled, without the emergence of stability problems.

In addition, it is advantageous that the inventive design of the tool holder with the above-described upper clamping surface and the likewise above-described resultant force vector produces a higher flexibility with respect to possible applications. Thus, since the lower clamping finger and/or the cutting insert must be designed less stable in comparison to earlier tools since because the acting clamping force acts rather in the main body than in the support, smaller supports can be realized, for instance. Such smaller supports enable the tool to be able in the axial grooving to cover a band width of various radii. This, in turn, yields economic advantages.

In a refinement, at least half of the upper clamping surface, considered along the longitudinal direction, is disposed between the workpiece-side end and the holder-side end of the main body.

In this refinement, it is hence defined that not only a resultant force vector of the clamping force acts in a region located between the workpiece-side end and the holder-side end of the main body, but that, in addition, at least half of the upper clamping surface is not over the projecting part of the lower clamping finger, but within the main body, i.e. above that part of the lower clamping finger which is disposed within the main body. The force effect on the lower clamping finger is thereby further reduced, whereby the inventive effect is enhanced.

A further refinement provides that the entire upper clamping surface, considered along the longitudinal direction, is disposed between the workpiece-side end and the holder-side end of the main body.

In this refinement, the entire upper clamping surface is thus disposed at the height of or within the main body. The foremost end of the upper clamping finger is then set back from the workpiece-side end of the main body of the holder in the longitudinal direction. Correspondingly, also the resultant force vector of the clamping force acts on a region which is offset in relation to the workpiece-side end of the main body rearward in the direction of the holder-side end. The lower clamping finger or the support is thereby subjected to still less load.

In a further refinement, the cutting insert extends substantially along a longitudinal axis from a holder-side end of the cutting insert to a workpiece-side end of the cutting insert. Moreover, the cutting insert has a workpiece-side region and a holder-side region. In the workpiece-side or front region of the cutting insert is disposed a cutting surface having at least one cutting edge. In the holder-side or rear region, the cutting insert has an upper bearing surface, disposed on a top side of the cutting insert, for bearing against the upper clamping surface of the upper clamping finger, and a lower bearing surface, disposed on a bottom side, lying opposite the upper bearing surface, of the cutting insert, for bearing against a lower clamping surface of the lower clamping finger.

Preferably, a cutting insert which is substantially cuboid and has a larger extent in the longitudinal direction than in the transverse or vertical direction is used. The longitudinal axis of the cutting insert is usually equidirectional with the longitudinal axis or longitudinal direction of the main body of the tool holder and corresponds to the feed direction of the tool. The vertical direction in the cutting insert, or a vertical axis of the cutting insert, denotes an axis which, in a clamped state in which the cutting insert is secured in the tool holder, corresponds substantially parallel to the clamping force exerted by the upper clamping finger on the cutting insert in the direction of the lower clamping finger. This vertical direction usually likewise corresponds to the cutting direction, i.e. the direction in which the chip removal is realized.

In addition, it is preferred that the lower bearing surface extends along the longitudinal axis substantially over the entire bottom side of the cutting insert in the workpiece-side region and in the holder-side region, wherein the upper bearing surface extends along the longitudinal axis only over a part of the top side of the cutting insert in the holder-side region.

The lower bearing surface thus preferably has in the longitudinal direction a larger extent than the upper bearing surface. Considered along the longitudinal direction, the lower bearing surface extends preferably over the entire length of the cutting insert and bears against the lower clamping finger both on its projecting part and on its part within the main body. The entire cutting insert preferably consists of hard metal. The cutting insert is preferably configured as a so-called single tooth cutter, in which only one cutting surface is provided.

In a further refinement, it is provided that, in the holder-side region of the cutting insert, a distance between the upper bearing surface and the lower bearing surface along the longitudinal axis in the direction of the holder side end of the cutting insert increases.

In other words, the cutting insert thus widens toward the rear. Since the cutting insert widens of its holder-side end, a mechanical return movement prevention of the cutting insert is achieved. Hence the upper clamping finger acts, for instance, on a surface which rises in the longitudinal direction, while the lower clamping finger acts on a surface which is oriented substantially parallel to the longitudinal axis of the cutting insert. This has the result that the cutting insert is not only immovable relative to the adjacent clamping fingers in the longitudinal direction due to frictional forces, but that, in addition thereto, also the wedge-shaped design of a longitudinal movement in the direction of the workpiece-side end of the cutting insert or of the tool holder is opposed.

In a further refinement, it is provided that the cutting insert has in the workpiece-side region, on its top side lying opposite the lower bearing surface, a chip guiding element, which is configured substantially as an oblique surface and forms with the longitudinal axis of the cutting insert an angle of 5° to 15° that opens in the direction of the holder-side end of the cutting insert.

Consequently, the chip guiding element is configured such that, by virtue of a gentle ascent, it enables a good chip flow. An angle in the region of 12° has proved particularly advantageous. This angle denotes a widening of the cutting insert in the vertical direction in the direction of the holder-side end of the cutting insert.

In a further refinement, it is provided that a maximum height of the chip guiding element above the lower bearing surface is larger than a minimum height of a top side, facing away from the upper clamping surface, of the upper clamping finger above the lower clamping surface of the lower clamping finger.

By “maximum height” of the chip guiding element above the lower bearing surface is understood a maximum distance between the chip guiding element and the lower bearing surface, i.e. the distance between the lower bearing surface and a point on the chip guiding element which has the greatest distance from the lower bearing surface. The maximum height of the chip guiding element thus corresponds to a maximum extent of the cutting insert in the vertical direction. By “minimum height” of the top side of the upper clamping finger above the lower clamping surface is understood the distance in the clamped state between the lower clamping surface and a point, situated closest thereto, on the top side of the upper clamping finger.

The chip guiding element, viewed in a side view, thus has a type of saw tooth profile. Usually, the upper clamping finger bears directly behind (away from the workpiece in the direction of the holder-side end of the cutting insert) the chip guiding element. In this terminology, the upper bearing surface is thus constantly behind the chip guiding element. Against this upper bearing surface bears the upper clamping finger. Since the maximum height of the chip guiding element is larger than the minimum height of the upper clamping finger, the cuttings can flow off freely.

The upper clamping finger is usually configured, in a longitudinal profile along the longitudinal axis of the main body of the tool holder, likewise in the shape of a wedge. However, for the exertion of the clamping force, it is usually necessary that the upper clamping finger, also at its foremost point, has a sufficient extent in the vertical direction. In order to prevent this front end of the upper clamping finger from hampering or impeding the chip flow, the above-described configuration of the cutting insert is provided.

According to a further refinement, the main body has, in a region between the upper clamping finger and the lower clamping finger, a stop face for the holder-side end of the cutting insert. A distance between the stop face and a workpiece-facing end of the upper clamping finger in the longitudinal direction of the main body is preferably smaller than a distance between a holder-side end of the chip guiding element and the holder-side end of the cutting insert along the longitudinal axis of the cutting insert.

The stop face prevents a displacement of the cutting insert in relation to the tool holder in the longitudinal direction. If the tool is moved in the direction of the workpiece (in the feed direction), force is applied in the direction of the longitudinal axis of the cutting insert or of the tool holder. This force application is opposed by the bearing surface. The stop face is preferably disposed on the lower clamping finger and oriented transversely to the longitudinal direction. The above-stated distance relationships mean that the cutting insert bears against the stop face, and that the chip guiding element, in particular on its side facing away from the workpiece, does not make contact with the upper clamping finger. In a side view along the longitudinal axis of the cutting insert and of the tool holder, a distance thus exists between the wedge or the saw tooth formed by the chip guiding element, and the upper clamping finger. This means that the forces acting in the longitudinal direction are transmitted directly into the main body and do not come to bear against the upper clamping finger.

According to a further refinement, the cutting insert has in the region of the upper bearing surface a prismatic cross section, wherein the upper bearing surface is formed of two mutually angled upper leg faces for bearing against the upper clamping finger. Accordingly the cutting insert, also has in the region of the lower bearing surface a prismatic cross section, wherein the lower bearing surface is likewise formed of two mutually angled lower leg faces for bearing against the lower clamping finger.

A prismatic cross section denotes a cross section in the form of a polygon. This prismatic cross section has, in particular on its side facing the upper bearing surface, two mutually angled legs, which correspond to the leg faces on the upper bearing surface. Both the upper and the lower bearing surface consequently consist respectively of at least two (part-)surfaces. These two leg faces respectively form an angle to each other. Preferably, the cross section in the region of the upper and the lower bearing surface respectively corresponds to the shape of an isosceles trapezium. Usually, the upper and the lower clamping finger of the tool holder have corresponding cross sections.

It should herein be noted that it is both possible that the cutting insert has a prismatic cross section only in the region of the lower or only in the region of the upper bearing surface. Preferably, however, a prismatic cross section is provided in both regions, so that the cross section of the cutting insert in the rear region (workpiece-side region) is doubly prismatic.

In a cross section transversely to the longitudinal axis of the cutting insert, the upper leg faces are preferably offset in relation to the lower leg faces transversely to the longitudinal axis.

It has transpired that a high stability is enabled by the fact that a trapezoidal surface which is formed by the upper leg faces and a trapezoidal surface which is formed by the lower leg faces are mutually offset in the transverse direction. Such an offset gives rise to a shearing force. As a result, a particularly secure seating of the cutting insert in the tool holder can be achieved.

According to a further refinement, the tool is configured for axial grooving, wherein the projecting part of the lower clamping finger (the support) has a substantially crescent-shaped cross section.

As already stated, a smallest possible dimensioning of the support is advantageous in particular when the tool is used for axial grooving and it is necessary that the support is of crescent-shaped configuration. The radius of the crescent-shaped cross section corresponds to the radius of the annular groove to be turned. A small annular groove hence requires a circular arc of small radius, which consequently results in a lower stability of the support.

In a further refinement, the crescent-shaped cross section has an outside radius and an inside radius, the inside radius being larger than the outside radius, and a center point of a circle assigned to the inside radius does not lie on a center point of a circle assigned to the outside radius.

As likewise already stated, this can enable annular grooves to be recessed in a radial region defined substantially by the radius of the inside radius and the radius of the outside radius of the cross section of the support. The inside radius denotes the radius which the support, viewed in cross section, forms on the side facing the central longitudinal axis (rotational axis) of the workpiece. Correspondingly, the outside radius denotes the radius of the support on its side facing away from the central longitudinal axis of the workpiece.

In a further refinement, it is preferably provided that the actuating element is configured as a clamping screw, which, through a recess in the upper clamping finger, engages in a thread in the main body.

As a result of this clamping screw, it is enabled that the upper clamping finger is drawn in the direction of the lower clamping finger. This offers the advantage of a simple and releasable clamping device, which allows the cutting insert to be secured between the upper and lower clamping finger. The clamping screw can be released quickly and easily, so that the cutting insert can be replaced, particularly in case of wear.

The above-stated features and the features which have yet to be set out below can be used not only in the respectively stated combination, but also in other combinations or in isolation, without departing from the spirit and scope of the present invention.

### BRIEF DESCRIPTION OF THE DRAWINGS

FIG. 1 shows a perspective representation of a tool for machining according to an embodiment of this disclosure;

FIG. 2 shows a front view of the embodiment shown in FIG. 1;

FIG. 3 shows a schematic representation of the clamping force exerted by the upper clamping finger in a profile view along a longitudinal axis of the tool;

FIG. 4 shows a representation of a second embodiment of the tool in profile view in the longitudinal direction;

FIG. 5 shows a representation of a third embodiment of the tool in profile view in the longitudinal direction;

FIG. 6 shows a perspective representation of a cutting insert according to an embodiment,

FIG. 7 shows a representation of the secured cutting insert in the tool in profile view in the longitudinal direction,

FIG. 8 shows a representation of the cutting insert in profile view and in two frontal views, and

FIG. 9 shows a cross-sectional view transversely to the longitudinal direction of the tool according to the tool.

### DESCRIPTION OF PREFERRED EMBODIMENTS

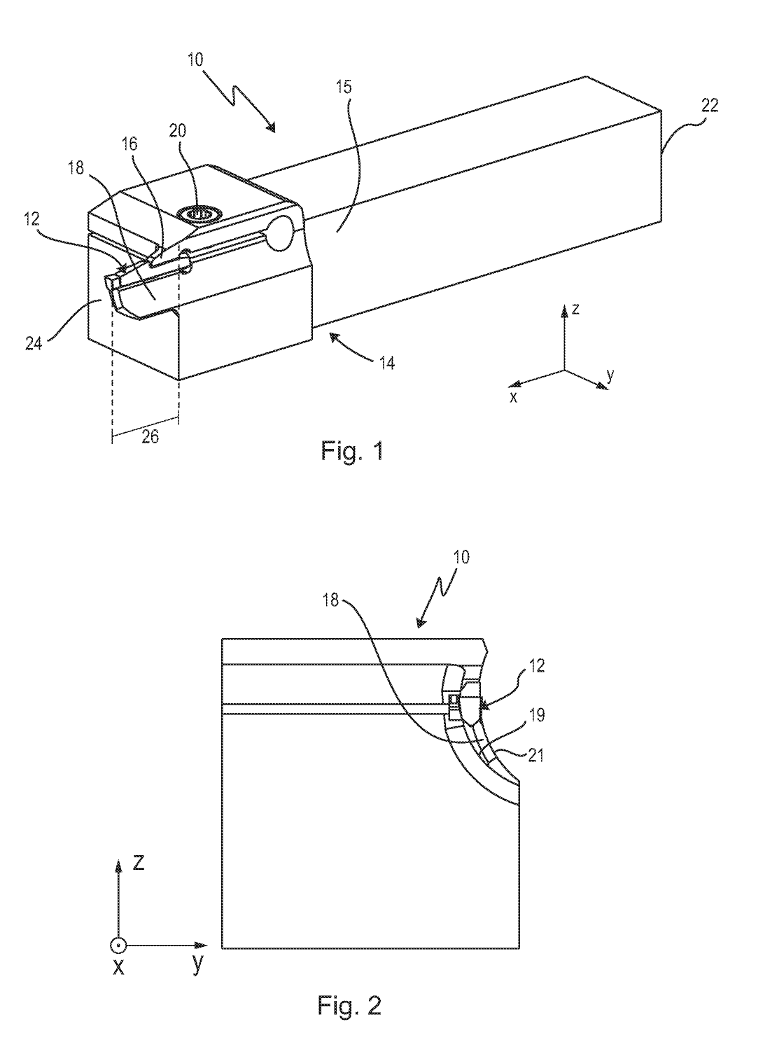

FIG. 1 shows a first illustrative embodiment 10 of a tool for machining a workpiece. The tool 10 has a cutting insert 12, which can be exchangeably secured in a tool or clamping holder 14. The tool holder 14 has a main body 15, as well as an upper clamping finger 16 and a lower clamping finger 18. The lower clamping finger 18 has a part projecting over the main body 15, which part is referred to as a support.

The cutting insert 12 is received between the upper clamping finger 16 and the lower clamping finger 18. The tool 10 additionally has an actuating element 20, by which the cutting insert 12 can be secured or clamped in place in the tool holder 14. In the present illustrative embodiment, the actuating element 20 is configured as a clamping screw, which through a recess in the upper clamping finger 16 engages in a thread in the main body 15. Naturally, however, the upper clamping finger 18 can also be of self-clamping design, so that no separate actuating element 20 is necessary. In this case, the upper clamping finger 18 could then be spread open, for instance, with the aid of a tool key, in order to exchange the cutting insert 12 in case of wear.

The main body 15 or the entire tool 10 extend substantially along a longitudinal direction x. In the clamped state, the longitudinal direction or axis x′ of the cutting insert 12 is preferably oriented parallel to the longitudinal direction x of the main body 15. The main body 15 has a holder-side end 22 and a workpiece-side end 24, wherein the workpiece-side end 24 is facing the tool during the machining and the holder-side end 22 is facing a corresponding holding apparatus for receiving the tool holder 14 in a machine tool.

The tool 10 shown in FIG. 1 is configured for grooving, in particular for axial grooving. In this case, the tool 10 is moved up to the workpiece in the longitudinal direction x and a chip removal takes place at the cutting insert 12. In the grooving operation, the feed direction is preferably oriented parallel to the longitudinal axis of the work-piece.

A part of the lower clamping finger 18, namely the so-called support, projects over the workpiece-side end 24 of the main body 15. The length 26 of the support maximally corresponds to the length of that part of the cutting insert 12 which in the clamped state projects over the main body 15, which part determines the maximum plunge depth of the tool 10.

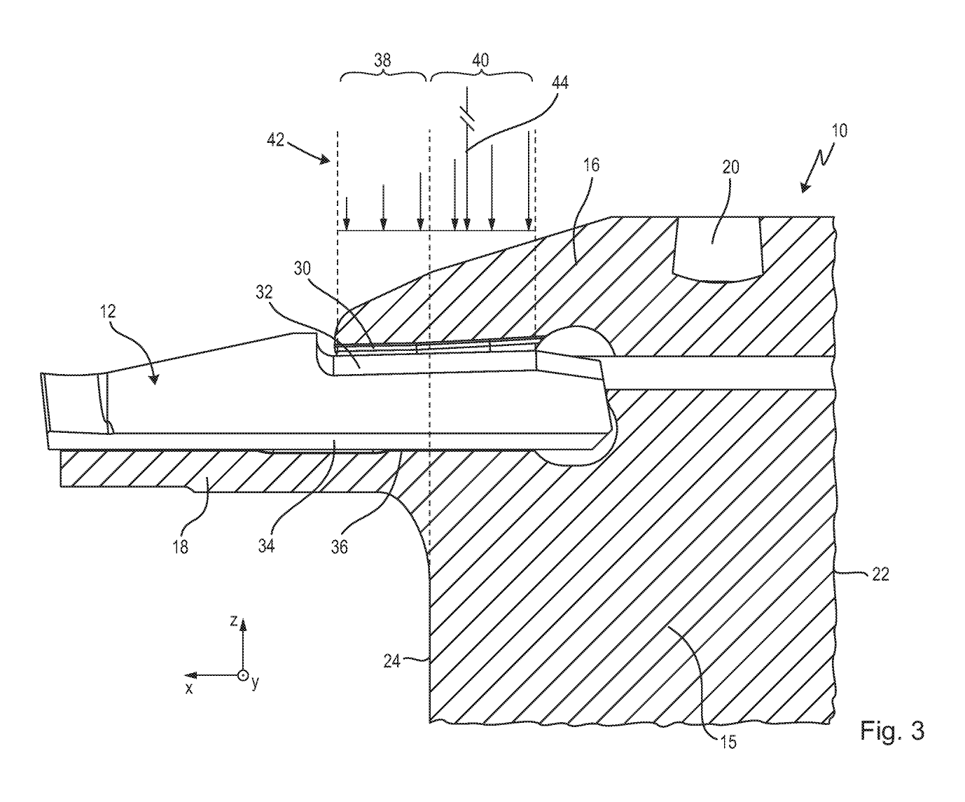

FIG. 2 shows a frontal view of the tool 10, viewed from the direction of the workpiece. The lower clamping finger 18, in particular in its part projecting over the main body 15, is of crescent-shaped configuration. This allows annular grooves to be produced in axial grooving. The minimum width of an annular groove is predefined by the width of the cutting insert 12. Through a movement of the tool 10 transversely to the grooving direction, the annular groove can be widened. In the present figure, the grooving is hence realized in the x-direction parallel to the rotational axis of the workpiece, and the widening of the annular groove is realized by a movement of the tool 10 in the y-direction. The radius of an annular groove to be recessed is limited both in the downward and in the upward direction by the radius of the support.

As can further be seen from FIG. 2, the cross section of the support has an outside radius 19 and a therefrom differing inside radius 21. Advantageously, the inside radius 21 is larger than the outside radius 19. The annular grooves produced by the tool 10 are restricted in their radial range in the downward direction by the outside radius 19 and in the upward direction by the inside radius 21 of the support. In order to avoid a collision of the tool with the support of the lower clamping finger 18, consequently no larger radius than the inside radius 21 and no smaller radius than the outside radius 19 of the support can be recessed.

On the other hand, the projecting part of the lower clamping finger 18 forms a force support for the cutting insert 12. The narrower the dimensioning of the support, the less stable becomes the total system and the greater the risk of destruction of the tool 10. Also the length of the support in the x-direction, which length is important for larger plunge depths, is limited, since too long a support (i.e. a lower clamping finger 18 projecting in the x-direction too far over the workpiece-side end 24 of the main body 15) would likewise lead to instability.

FIG. 3 shows a view of a tool 10 according to an embodiment in profile along the longitudinal axis x of the main body 15. The upper clamping finger 16, via an upper clamping surface 30 disposed thereon, exerts a clamping force on the cutting insert 12. This clamping force is transmitted into the cutting insert 12 via an upper bearing surface 32 on the latter and then acts on a lower clamping surface 36 on the lower clamping finger 18 via a lower bearing surface 34 on the cutting insert 12. The force is usually transmitted areally on the lower clamping finger 18, both in its projecting part and in its part lying within the main body 15, into the main body 15.

In the clamping or securement of the cutting insert 12 by means of the clamping screw 20, a front or workpiece-side region 38 of the upper clamping finger 16 first touches the cutting insert 12. Upon further clamping, this front region 38 of the upper clamping finger 16 is elastically deformed, until also the rear or holder-side region 40 of the upper clamping finger 16 comes into contact with the cutting insert. 12. The front region 38 of the upper clamping finger is hence designed such that it bends. It can thus be achieved that the force effect in the front region 38 of the upper clamping finger 16 is only relatively small, whereby bending of the projecting part of the lower clamping finger 18 is prevented. This gives rise to the force profile 42, shown schematically in FIG. 3, at the contact surface between the upper clamping finger 16 and the top side of the cutting insert 12.

It is provided that at least a part of the upper clamping surface 30 of the upper clamping finger 16, considered along the longitudinal direction x, lies between the workpiece-side end 24 and the holder-side end 22 of the main body 15. A part of the upper clamping surface 30 is thus not disposed above the projecting part of the lower clamping finger 18 (the support), but within the main body 15 or behind the workpiece-side end 24 of the main body 15.

Of course, from other dimensionings and from other geometries of the tool 10, force profiles other than force profile 42 represented schematically in FIG. 3 can also be obtained. The force profile 42 represented in FIG. 3 should be understood merely as an example. It is important, however, that a resultant force vector 44, which is obtained from the sum or integration of the areally acting clamping force, acts on the cutting insert 12 in a region which, considered along the longitudinal direction x, extends between the workpiece-side end 24 and the holder-side end 22 of the main body 15. In particular, the resultant force vector 44 hence acts within the main body 15 and not directly on the projecting part of the lower clamping finger 18, i.e. on the support. This has the advantage that the force on the support is kept as low as possible. As a result, the dimensioning of the support can be chosen minimally small.

Furthermore, the elastic deformation of the upper clamping finger 16 in its first region 38 during the chip-forming process yields advantages. If, for instance, in the chip-forming process, a cutting force (normally counter to the represented z-direction) acts on the cutting insert 12, the latter, together with the projecting part of the lower clamping finger 18, is “bent” downward (in the z-direction). Consequently, the cutting insert 12 is also guided under load (i.e. also during the chip-forming process) up to the foremost point (on the side of the workpiece) of the upper clamping finger 16.

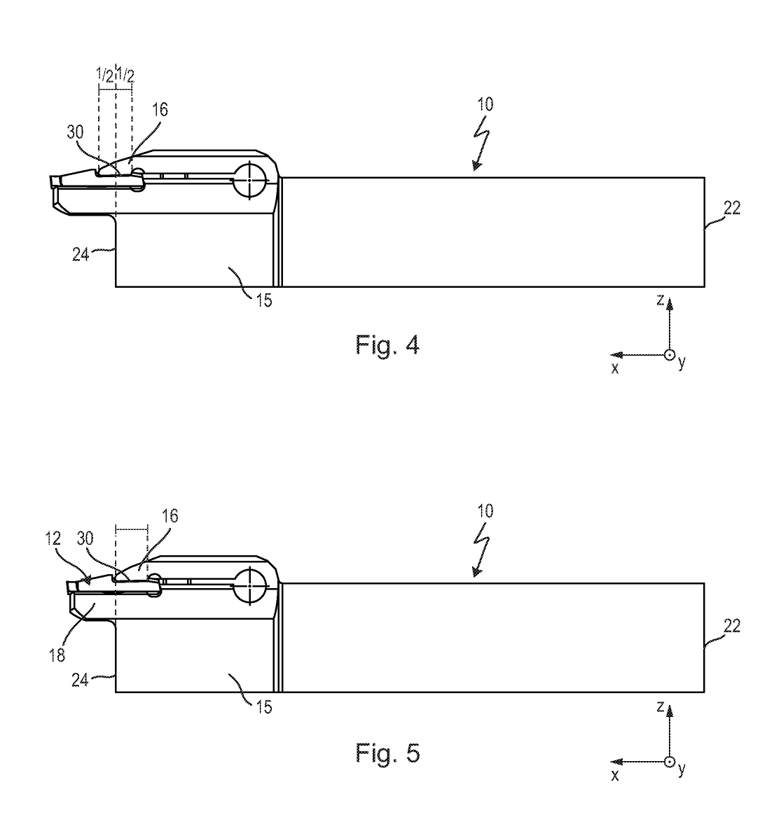

FIG. 4 shows a profile view of a second embodiment of the tool 10. In this embodiment, not just a part of the upper clamping surface 30, considered along the longitudinal direction x, is located between the workpiece-side end 24 and the holder-side end 22 of the main body 15, but at least half thereof. The resultant force vector of the clamping force likewise (still) lies within the main body 15, i.e. between its workpiece-side end 24 and its holder-side end 22.

FIG. 5 shows a third embodiment of the tool 10. The entire upper clamping surface 30 of the upper clamping finger 16 is located within the main body 15, i.e. between its workpiece-side end 24 and its holder-side end 22. It is hereby ensured that the resultant force vector 44 acts in any event (irrespective of the force profile) within the main body 15. Hence the force effect which is obtained, on the basis of the clamping force exerted by the upper clamping finger 16, through the cutting insert 12 onto the projecting part of the lower clamping finger 18 is reduced still further. Consequently a relative small dimensioning of the support can be chosen, because now the entire clamping force is transmitted directly into the main body 15 of the tool holder 14.

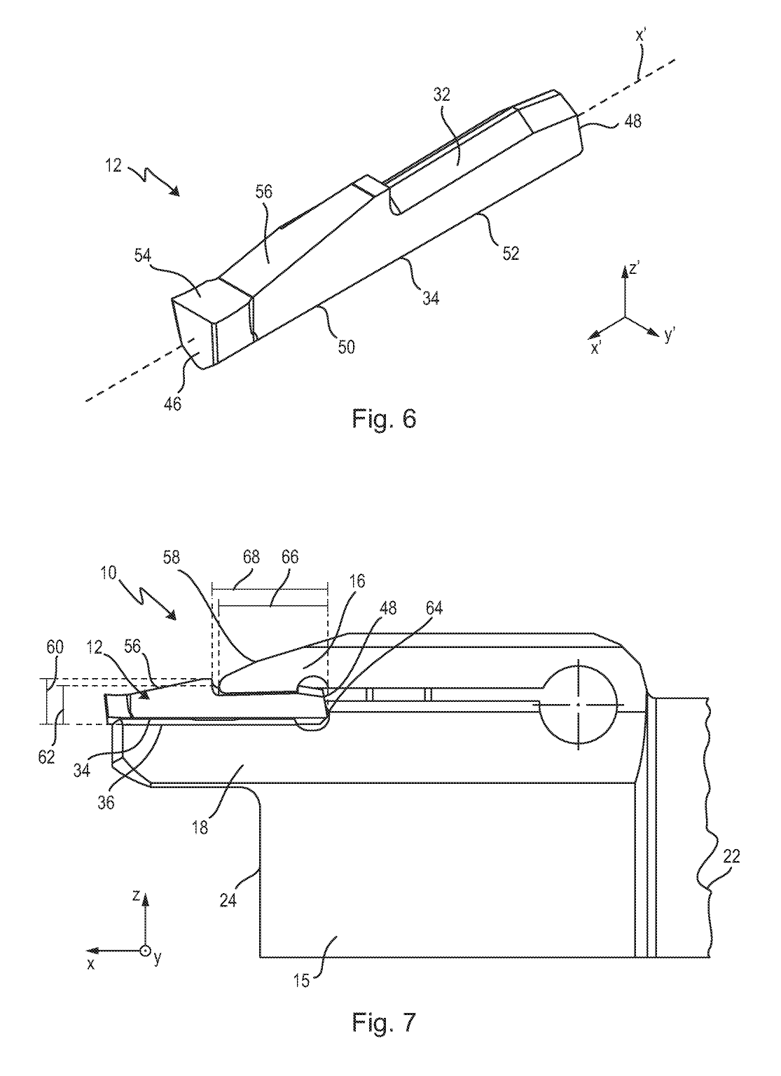

FIG. 6 shows a perspective representation of a cutting insert 12. The cutting insert 12 extends substantially along a longitudinal axis x likewise from a workpiece-side end 46 to a holder-side end 48. The cutting insert 12 has substantially a workpiece-side region 50 and a holder-side region 52. In the workpiece-side region 50 is found a cutting surface 54, at which the actual chip removal takes place. The entire cutting insert 12 is preferably produced from hard metal. In contrast thereto, the tool holder 14 is usually produced not from hard metal, but preferably from steel.

In its holder-side region 52, the cutting insert 12 has an upper bearing surface 32 for bearing against the upper clamping finger 16. Lying opposite this upper bearing surface 32 is a lower bearing surface 34, which in the present illustrative embodiment extends over the entire bottom side of the cutting insert 12 and bears against the lower clamping finger 18 both in its projecting part and in its part within the main body 15. The clamping force acts on the lower bearing surface 34, and thus on the lower clamping finger 16, via the upper bearing surface 32 through the cutting insert 12.

The cutting insert 12 advantageously has in its workpiece-side region 50 a chip guiding element 56. This chip guiding element 56 is configured substantially as an oblique surface and forms with the longitudinal axis x′ of the cutting insert 12 preferably an angle of 5° to 15°. Via this chip guiding element 56, the chips cut off at the cutting surface are evacuated. In particular, an angle of 12° has proved particularly advantageous in this respect. A flat chip guiding element 56 allows an unimpeded chip flow, in which the chip does not break too quickly, yet nor is it curled. A uniform chip flow, in particular in the recessing of annular grooves by axial grooving, is necessary to prevent jamming of the tool by cuttings which accumulate in the annular groove.

FIG. 7 shows an embodiment of the tool 10 according to this disclosure in profile view. It has additionally proved advantageous that the chip guiding element 56 on the cutting insert 12 is continued by the front side 58 of the upper clamping finger 16. As a result, the chip flow is further aided. The cuttings thus run firstly over the chip guiding element 56 and then over the front side 58 of the upper clamping finger 16. In order to enable an unimpeded chip flow, it is usually necessary that the maximum height 60 of the chip guiding element 56 above the lower clamping surface 36 of the cutting insert 12 is greater than a minimum height 62 of the top side, facing away from the upper clamping surface 30, of the upper clamping finger 16 above the lower clamping surface 34 in the clamped state. In particular, in this embodiment it is advantageous that the cuttings which flow off via the chip guiding element 56 do not get caught on the upper clamping finger 16. The front edge 58 of the upper clamping finger 16 hence tapers in the direction of the workpiece and terminates at a point which lies below the topmost point of the chip guiding element 56.

Furthermore, the main body 15 has in a region between the upper clamping finger 16 and the lower clamping finger 18 a stop face 64, against which the holder-side end 48 of the cutting insert 12 in the clamped state bears. This stop face 64 requires that the cutting insert 12 cannot be displaced in the x-direction in relation to the main body 15. If hence the tool 10 plunges into the workpiece in the feed direction x, a force acts on the stop face 64 through the cutting insert 12. In the present embodiment of the tool 10, the stop face 64 is provided in the region of the lower clamping finger 18, or as is fashioned as a projection on the lower clamping finger 18. In other embodiments, however, it is likewise possible that the stop face 64 is located on the upper clamping finger 16.

Furthermore, it is provided according to this disclosure that a distance 66 between the stop face 64 and a workpiece-facing end of the upper clamping finger 16 in the longitudinal direction x of the main body 15 is smaller than a distance 68 between the holder-side end of the chip guiding element 56 and the holder-side end 48 of the cutting insert 12 along the longitudinal axis x′ of the cutting insert 12. Hence the cutting insert 12, in the clamped state, bears only at its holder-side end 48 against the main body 15, transversely to the longitudinal direction x. At the end of the chip guiding element 56, there is no point of abutment or no contact with the upper clamping finger 18.

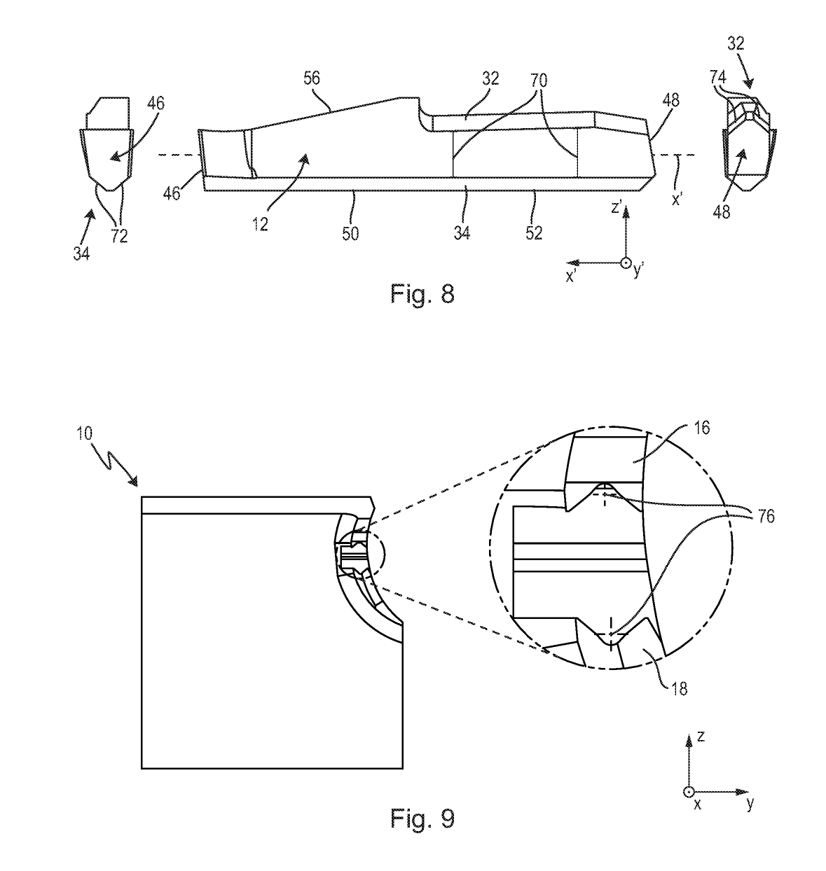

FIG. 8 shows in the middle a profile view of the cutting insert 12 along its longitudinal direction x. In a preferred embodiment of this disclosure, the cutting insert 12 widens in its holder-side region 52 in the vertical direction z in the direction of its holder-side end 48. Hence the distance 70 between the upper bearing surface 32 and the lower bearing surface 34 increases from the workpiece-side end 46 in the direction of the holder-side end 48 of the cutting insert 12. As a result of this widening in the holder-side region 52 of the cutting insert 12, a return movement prevention is achieved.

On the left side, FIG. 8 shows a frontal view of the cutting insert 12, viewed from the direction of the workpiece (counter to the x-direction). In particular, the frontal view represented on the left side in FIG. 8 shows the cross section of the cutting insert 12 in its workpiece-side region 50 or its workpiece-side end 46. The cutting insert 12 has on its lower side (lower bearing surface 34) a prismatic cross section. This bottom side, i.e. the lower bearing surface 34, is not configured in one piece, but consists of two mutually angled lower leg faces 72. In an advantageous configuration of this disclosure, these lower leg faces 72 bear against a correspondingly shaped lower clamping surface on the lower clamping finger 18. This has the effect, in particular, that a transverse displacement of the cutting insert 12 in the y-direction is prevented or made more difficult. As a result, a more stable seating of the cutting insert 12 in the tool holder 14 can be achieved.

On the right side in FIG. 8, a corresponding frontal view of the cutting insert 12 from the direction of the tool holder 14 is represented. The diagram hence shows the holder-side end 48 of the cutting insert 12. In particular, the cross section in the holder-side region 52 of the cutting insert 12 is represented. In this holder-side region 52, the cutting insert 12 has in the region of the upper bearing surface 32 likewise a prismatic cross section, in which the upper bearing surface 32 consists of two mutually angled upper leg faces 74 for bearing against the upper clamping finger 16. This prismatic cross section, similarly to the previously described prismatic cross section in the region of the lower clamping finger 18, opposes a displacement of the cutting insert 12 in the transverse direction y.

The prismatic cross section is in the region of the lower bearing surface 34 advantageously configured over the entire length of the cutting insert 12, wherein the prismatic cross section is in the region of the upper bearing surface 32 configured only in the region of the holder-side end 52 of the cutting insert 12.

The present illustrative embodiment shows a design of the upper and lower leg faces 72, 74 in each case as an outer prism. In further embodiments of this disclosure, another realization as an inner prism or as a multi-face prism, by which, in interaction with correspondingly designed upper and lower clamping surfaces on the upper and lower clamping finger 16, 18, a comparable effect can be achieved, is also conceivable.

In an advantageous embodiment, the upper leg faces 74 are also offset by a few tenths in relation to the lower leg faces 72 in the transverse direction y. This offset results in the generation of shearing forces which produce a more stable seating of the cutting insert 12.

FIG. 9 shows a cross section through the tool 10 in the longitudinal direction x in that region in which the cutting insert (not represented) bears against the upper clamping finger 16 and the lower clamping finger 18. On the right side, an enlargement of a region marked on the left side is represented. In particular, it is evident that the upper clamping finger 16 and the lower clamping finger 18 likewise have a corresponding prismatic cross section which enables a cutting insert configured as a prism or double prism to be received in the region of its upper and lower bearing surfaces.

As represented in FIG. 9, it is likewise possible that the receiving regions 76 on the upper clamping finger 16 and on the lower clamping finger 18 are configured mutually offset in the transverse direction y. As a result, a further stabilized seating of the cutting insert 12 in the tool holder 14 is achieved.

What is claimed is:

1. A tool for machining a workpiece, comprising
a cutting insert; and
a tool holder, which has a main body, an upper clamping finger and a lower clamping finger,
wherein the main body extends along a longitudinal direction (x) from a holder-side end to a workpiece-side end;
wherein a projecting part of the lower clamping finger projects over the workpiece-side end of the main body;
wherein the upper clamping finger and the lower clamping finger together form a receiving fixture for the cutting insert, in which the cutting insert may be fixed such that the upper clamping finger, via an upper clamping surface disposed thereon, exerts a clamping force on the cutting insert,
wherein at least a part of the upper clamping surface is disposed between the workpiece-side end and the holder-side end of the main body, and a force vector of the clamping force acts in a region which is located between the workpiece-side end and the holder-side end of the main body, and
wherein the projecting part of the lower clamping finger has a substantially crescent-shaped or arc-shaped cross section.

2. The tool as claimed in claim 1, wherein at least half of the upper clamping surface is disposed between the workpiece-side end and the holder-side end of the main body.

3. The tool as claimed in claim 1, wherein the entire upper clamping surface is disposed between the workpiece-side end and the holder-side end of the main body.

4. The tool as claimed in claim 1, wherein the cutting insert extends along a longitudinal axis from a holder-side end of the cutting insert to a workpiece-side end of the cutting insert, has a workpiece-side region having a cutting surface, and a holder-side region having an upper bearing surface that is disposed on a top side of the cutting insert, for bearing against the upper clamping surface of the upper clamping finger, and having a lower bearing surface that is disposed on a bottom side opposite the top side, for bearing against a lower clamping surface of the lower clamping finger.

5. The tool as claimed in claim 4, wherein the lower bearing surface extends along the longitudinal axis substantially over the entire bottom side of the cutting insert in the workpiece-side region and in the holder-side region, wherein the upper bearing surface extends along the longitudinal axis only over a part of the top side of the cutting insert in the holder-side region.

6. The tool as claimed in claim 4, wherein, in the holder-side region of the cutting insert, a distance between the upper bearing surface and the lower bearing surface increases along the longitudinal axis in the direction of the holder side end of the cutting insert.

7. The tool as claimed in claim 4, wherein the cutting insert has in the workpiece-side region, on its top side a chip guiding element, which is configured as an oblique surface and forms with the longitudinal axis of the cutting insert an angle of 5° to 15° that opens in the direction of the holder-side end of the cutting insert.

8. The tool as claimed in claim 7, wherein a maximum height of the chip guiding element above the lower bearing surface is larger than a minimum height of a top side of the upper clamping finger above the lower clamping surface of the lower clamping finger.

9. The tool as claimed in claim 7, wherein the main body has, in a region between the upper clamping finger and the lower clamping finger, a stop face for the holder-side end of the cutting insert, wherein a distance between the stop face and a workpiece-facing end of the upper clamping finger in the longitudinal direction of the main body is smaller than a distance between a holder-side end of the chip guiding element and the holder-side end of the cutting insert along the longitudinal axis of the cutting insert.

10. The tool as claimed in claim 4, wherein the cutting insert has in a region of the upper bearing surface a prismatic cross section, wherein the upper bearing surface is formed of two mutually angled upper leg faces for bearing against the upper clamping finger.

11. The tool as claimed in claim 10, wherein the cutting insert has in a region of the lower bearing surface a prismatic cross section, wherein the lower bearing surface is formed of two mutually angled lower leg faces for bearing against the lower clamping finger.

12. The tool as claimed in claim 11, wherein, in a cross section transversely to the longitudinal axis of the cutting insert, the upper leg faces are offset in relation to the lower leg faces transversely to the longitudinal axis.

13. The tool as claimed in claim 1, wherein the tool is configured for axial grooving.

14. The tool as claimed in claim 1, wherein the projecting part of the lower clamping finger has a crescent-shaped cross section, wherein an outside radius of said crescent-shaped cross section is smaller than an inside radius of said crescent-shaped cross section.

15. The tool as claimed in claim 1, wherein the upper clamping finger comprises a recess and the main body comprises a thread, an wherein the cutting insert is securable in the receiving fixture by means of a clamping screw, which, through the recess in the upper clamping finger, engages in the thread in the main body.
